(19) United States
(12) Patent Application Publication
(10) Pub. No.: US 2022/0291738 A1
(43) Pub. Date: Sep. 15, 2022

(54) METHODS AND SYSTEMS FOR AUTOMATICALLY SAVING POWER DURING AN UPGRADE OF A DEVICE

(71) Applicant: XEROX CORPORATION, Norwalk, CT (US)

(72) Inventors: Nikitha Mareedu, Telangana (IN); Naveenraj Kaliarajan, Tamil Nadu (IN); Jagadeesh Panabakam, Chennai (IN)

(73) Assignee: XEROX CORPORATION, Norwalk, CT (US)

(21) Appl. No.: 17/197,652

(22) Filed: Mar. 10, 2021

(51) Int. Cl. G06F 1/3287; H04N 1/00

(52) U.S. Cl. CPC G06F 1/3287; H04N 1/00896; H04N 1/00538; H04N 1/00037; H04N 1/00053

(57) ABSTRACT

The disclosure describes methods and systems for power saving during an upgrade at a device such as a multi-function device. The device includes one or more modules, wherein each module is having an independent power supply. An application runs on the device to identify whether an upgrade is available at the multi-function device. Then, the application identifies one or more modules requiring the upgrade. Once the modules are identified, upgrade for the one or more identified modules is initiated by continuing to provide power to the identified modules. And power to the remaining modules i.e., modules not requiring any upgrade, is disabled from the start of the upgrade process till completion of the upgrade process in order to save overall power consumption of the device.

### TECHNICAL FIELD

The present disclosure relates to the field of power saving. More specifically, the disclosure relates to methods and systems for automatically saving power/energy during an upgrade process at a device.

### BACKGROUND

Various devices such as multi-function devices receive upgrades that can enhance the functionality and/or security aspects of the devices. While the upgrade process in under progress, users cannot perform any operations on these devices. However, the power consumed by the devices during the upgrade process is almost same as that of the power consumed by the device, when the device works in normal operating mode i.e., when the device is ready for use by users. A number of power saving options/solutions are available in the market but almost all available solutions focus on saving power when the device is working or is in normal operating mode. Currently, there are no methods and systems available that can provide power saving options during an upgrade. Hence, there is a need for methods and systems to cater to the above-mentioned problems.

### SUMMARY

According to aspects illustrated herein, a method for saving power during an upgrade at a device such as a multi-function device, is disclosed. An application runs on the device to identify whether an upgrade is available at the multi-function device, wherein the multi-function device having a plurality of modules, where each module having an independent power supply line to provide power to respective modules. Then, the application identifies one or more modules requiring the upgrade. Once the modules are identified, upgrade for the one or more identified modules is initiated by continuing to provide power to the identified modules. And power to remaining modules i.e., modules not requiring any upgrade, is disabled from the start of the upgrade process till completion of the upgrade process for the identified modules, in order to save power.

According to further aspects illustrated herein, a device for saving power during an upgrade executed at the device is disclosed. The device includes a main power supply; a plurality of modules to perform one or more functionalities, wherein each module includes an independent power supply line to provide power to respective module, wherein each independent power supply line is coupled to the main power supply; and an upgrade controller, communicatively coupled to the main power supply and each of the independent power supply lines for: identifying whether an upgrade is available at the device; identifying one or more modules of the plurality of modules, requiring the upgrade; and initiating upgrade process for the one or more identified modules requiring upgrade by continuing providing power to the one or more identified modules via respective power supply lines; and disabling power supply for the remaining modules, from start of the upgrade process till completion of the upgrade process in order to save power.

According to additional aspects illustrated herein, a non-transitory computer-readable medium including instructions executable by a processing resource is disclosed. The processing resource is to: identify whether an upgrade is available at a device, wherein the device having a plurality of modules, where each module having an independent power supply line to provide power to respective module; identify one or more modules of the plurality of modules of device requiring the upgrade; and initiate the upgrade process for the one or more identified modules requiring upgrade by continuing providing power to the one or more modules via respective power supply lines; and disable power supply for the remaining modules not requiring any upgrade having independent power supply, from start of the upgrade process till completion of the upgrade process in order to save power of the device.

Other and further aspects and features of the disclosure will be evident from reading the following detailed description of the embodiments, which are intended to illustrate, not limit, the present disclosure.

### BRIEF DESCRIPTION OF THE DRAWINGS

The illustrated embodiments of the subject matter will be best understood by reference to the drawings, wherein like parts are designated by like numerals throughout. The following description is intended only by way of example, and simply illustrates certain selected embodiments of devices, systems, and processes that are consistent with the subject matter as claimed herein.

FIG. 1 shows an exemplary environment in which various embodiments of the present disclosure can be practiced.

FIG. 2 is a block diagram illustrating various modules of a device, in accordance with an embodiment of the present disclosure.

FIG. 3 shows exemplary modules of the device with independent power supply feature/line for each module.

FIG. 4A illustrates exemplary power/line circuit diagram indicating independent power supply lines having a load switch for each power line; FIG. 4B shows exemplary load switch with control circuit mechanism.

FIG. 5 is a method flowchart for automatically saving power at a device during an upgrade.

### DESCRIPTION

A few inventive aspects of the disclosed embodiments are explained in detail below with reference to the various figures. Embodiments are described to illustrate the disclosed subject matter, not to limit its scope, which is defined by the claims. Those of ordinary skill in the art will recognize a number of equivalent variations of the various features provided in the description that follows.

### Non-Limiting Definitions

In various embodiments of the present disclosure, definitions of one or more terms that will be used in the document are provided below. For a person skilled in the art, it is understood that the definitions are provided just for the sake of clarity and are intended to include more examples in addition to the examples provided below.

The term “multi-function device” is a device capable of performing one or more functions such as, but not limited to, printing, imaging, scanning, and so forth. The multi-function device includes one or more modules to perform various functionalities, wherein each module includes an individual or independent power line/power supply line. In the context of the current disclosure, the multi-function device manages or controls overall power/energy consumption of the multi-function device or its modules during an upgrade. The power consumption can be controlled by disabling power for modules not requiring any upgrade and by continuing to provide power to modules requiring upgrade via their respective power supply lines.

The term “independent power supply line” refers to a dedicated power supply line to provide power to a specific module. For example, a print engine may have an independent power supply to provide power to the print engine and its further sub-modules only, while a scan engine includes its individual power supply line to provide power to the scan engine. The independent power supply line can be controlled individually, i.e., enabled, or disabled based on the requirement. For example, the power supply line of a scan engine can be disabled if the scan engine does not require any upgrade and it can be enabled again when the upgrade for other modules is completed successfully. Such modules with independent power supply may be termed as independent modules.

The term “upgrade” refers to an upgrade related to the multi-function device or to any of its modules. The upgrade may be to enhance the functionality of the device or its modules or may be to provide security. For example, the upgrade may be related to a print engine, a scan engine, a feeder engine, a user interface, or the like.

The term “disable” refers to turning-off power for one or more modules through their respective individual power supply lines and the term “enable” refers to turning-on power for one or more modules through their respective individual power supply lines.

### Overview

When an upgrade runs on any device such as a multi-function device, the multi-function device is not available for any operations during the upgrade process. But the power is supplied to all modules/components of the multi-function device even if the upgrade is not needed for all the modules. For example, if scan related updates are available in one new software then its waste to keep supplying power to print engine/module during the whole upgrade process. Further, the power consumed by the multi-function device during the upgrade process is almost similar to the power consumed by the multi-function device during normal operating mode. To solves these problems, the present disclosure is provided.

The present disclosure provides a solution by selectively providing/enabling power to modules that are getting upgraded at the multi-function device and disabling power for the remaining modules i.e., the modules not requiring any upgrade, in order to save overall power supplied to the multi-function device during the upgrade process. This approach of selectively enabling and disabling power helps optimize the overall power consumed by the multi-function device during the upgrade process.

### Exemplary Environment

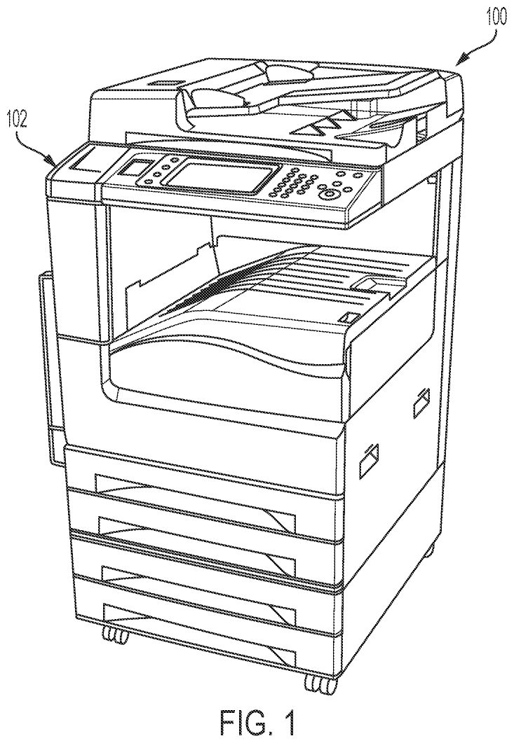

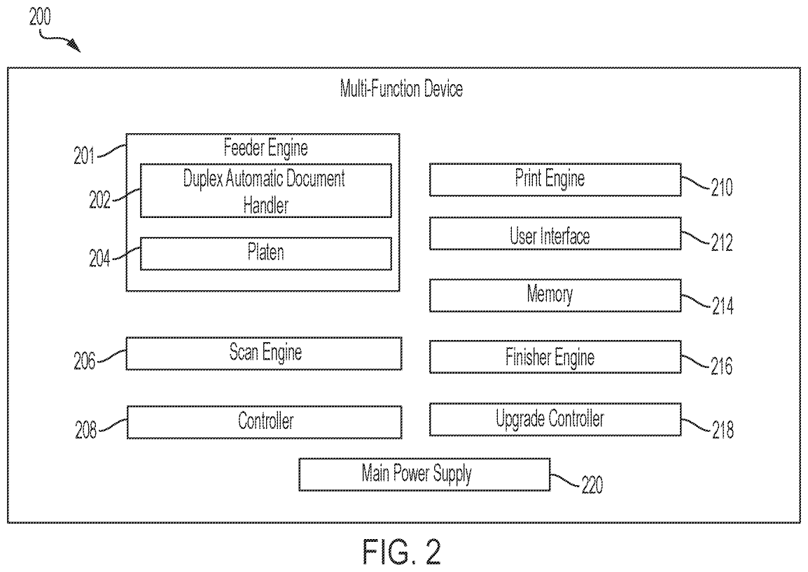

FIG. 1 shows an exemplary environment 100 in which various embodiments of the disclosure can be practiced. The environment 100 includes an exemplary device such as a multi-function device 102 for implementing the current disclosure. Typically, the multi-function device 102 may be used by users for printing, scanning, copying, imaging, filling out forms or various other functionalities at the multi-function device 102. The multi-function device 102 is communicatively coupled to a power source that provides electric power to the multi-function device 102 for functioning. The multi-function device 102 further includes a plurality of modules (shown in FIG. 2) such as a print engine, a scan engine, a user interface and so on, for performing various functionalities. In context of the present disclosure, each module includes an individual/independent power supply further connected to a main power supply such that power supply to each of the modules can be controlled individually.

During an upgrade, some of the modules may be required, while other modules may not be required. The upgrade can be automatically received on the multi-function device 102 from a back-end server. The upgrade can be received manually from a user or an admin user. For instance, the upgrade may be in any storage device such as a hard disk, a Universal Serial Bus (USB), or the like. The storage devices can be plugged into the multi-function device 102 and the upgrade can be manually initiated by the user. At the time of upgrade, the multi-function device 102 generates a notification for the user indicating the upgrade is in progress and the device 102 may not be available for use. The notification may be provided to all users of the multi-function device 102 or to users whose jobs are present at the multi-function device 102. The notification may be displayed on a user interface of the multi-function device 102 or may be sent through other ways such as text messages, emails and so on.

In context of the current disclosure, the multi-function device 102 incorporates an energy/power saving mechanism during an upgrade, which controls or manages power supplied to each module of the multi-function device 102. The power saving mechanism is implemented such that power supply to each module can be controlled individually. For example, the power saving mechanism disables power to modules that do not require upgrade and continues providing power to modules that are to be upgraded or required during the upgrade process. For example, if the upgrade related to a print engine is received, the multi-function device 102 continues providing power to the print engine so that the print engine can be upgraded but disables power to the scan engine. Similarly, if the upgrade related to a scan engine is received, the multi-function device 102 continues providing power to the scan engine but disables power to the print engine as the print engine is not required when the scan engine is being upgraded. In further example, if the upgrade related to the print engine and scan engine is received, the multi-function device 102 executes the upgrade in a sequential manner i.e., the print engine may be upgraded first and the scan engine may be upgraded after that. In such cases, the multi-function device 102 disables power supply for the scan engine till upgrade related to the print engine is completed successfully. While upgrading the scan engine, the multi-function device 102 disables power for the print engine till upgrade related to the scan engine is completed successfully. This way, the multi-function device 102 manages overall power consumption of the device during the upgrade process.

The present disclosure provides methods and systems for managing power of devices such as multi-function devices during an upgrade. The methods and systems manage power during the upgrade such that components requiring upgrade are provided with the required power but power for remaining modules i.e., modules not requiring any upgrade is disabled. This way, the overall power consumed by the multi-function device can be reduced, and performance of the device can be enhanced/optimized.

### Exemplary Device

FIG. 2 is a block diagram of a device 200 such as a multi-function device, illustrating various modules of the multi-function device 200 for implementing the present disclosure. As shown, the multi-function device 200 includes various modules/components such as a DADH (Duplex Document Automatic Handler) 202, a platen 204 (collectively may be referred to as a feeder engine 201), a scan engine 206, a controller 208, a print engine 210, a user interface 212, a memory 214, a finisher engine 216, an upgrade controller 218, and a main power supply 220. The scan engine 206 may be termed as image-input terminal (IIT) and the print engine 210 may be termed as image-output terminal (IOT). The modules 201-220 are connected to each other via a conventional bus or a later developed protocol. Further, the modules 201-220 communicate with each other for performing various functions of the present disclosure. The modules 201-220 as shown are exemplary in nature, it is understood that the multi-function device 200 may include more or lesser modules as required for implementing the disclosure without limiting the scope of the disclosure. For example, the multi-function device 200 may include an additional module such as a copy controller. In another example, the multi-function device 200 may include a single module having the feeder engine 201 and the scan engine 206.

A shown, the multi-function device 200 includes the main power supply 220 that is connected to a commercial power source via a power supply cable (although not shown) and supplies power to the multi-function device 200 or each of the modules 201-218. The multi-function device 200 may be supplied with an alternating-current voltage of any desired suitable volts. The multi-function device 200 may have power supply that supplies a direct-current voltage. Examples of the main power supply 220 may be a low voltage power supply (LVPS) system, a high voltage power supply system (HVPS), or the like. The main power supply 220 may supply any power required for the multi-function device 200 to perform its operation/functions. For example, the power for the multi-function device 200 may be 240 watts (12 volts @ 20 amps).

In context of the present disclosure, the main power supply 220 distributes power to each of the modules 201-218 of the multi-function device 200. The power source provides power to the main power supply 220 of the multi-function device 200 which then further goes to individual power supply lines to power respective modules. Each of the modules 201-218 includes an individual power supply line that can be controlled individually.

Each of the individual power supply line includes a switch part. For example, the switch may be a power relay switch that is used individually to control the power of these modules 201-220. But the switch may be electrically operated switch. For example, each of the power supply line includes a load switch that is used to ‘switch on’ or ‘switch off’ the power of the respective module. The switch can be opened or closed according to signals from the upgrade controller 218 to enable or disable individual power supply line, respectively. In one example, the switch may implement a load switch circuit mechanism to enable/disable the power supply lines for the modules 202-218. In another example, each of the individual power supply line includes a switch that can be toggled to an ON state or to an OFF state. The ON state enables the power supply to that particular module and the OFF state disables the power supply to that particular module.

Each of the modules 202-218 may need different amount of power to function such as 5 volts, 24 volts, 3 volts, 48 volts and so on. As one example, the user interface 212 may need 5 volts, the DADH 202 may need 24 volts and the scan engine 206 may need 48 volts.

Further, each of the modules 201-218 performs various functionalities. For example, the feeder engine 201 receives input from a user in the form of printed papers for scanning either through the platen 204 or through the DADH 202. The scan engine 206 scans one or more documents and outputs a scanned document to one or more desired destinations. The print engine 210 prints based on print attributes as received from a user. The user interface 212 displays various messages or alerts to the user and further allows the user to do any selection. The controller 208 controls the operations related to the multi-function device 200 and communicates with other modules 202, 204, 206, 210, 212, 214, 216, and 218, while executing any functionality at the multi-function device 200. The memory 214 stores all required information such as print attributes, scanned documents, user details, job details, upgrade details, multi-function device's details, or any other information required for implementing the present disclosure. The details stored in the memory 214 can be retrieved by the controller 208 or by the upgrade controller 218 for implementing the present disclosure. The finisher engine 216 finishes any print job as received from the controller 208, for example, staple, hole punch and so on. The upgrade controller 218 manages all upgrades received at the multi-function device 200 and ensures upgrades are completed successfully at the multi-function device 200. The upgrade controller 218 upgrades the multi-function device 200 or any of its modules 202-218 based on the available upgrade at the device 200.

In context of the present disclosure, the upgrade controller 218 checks whether there is any upgrade available at the multi-function device 200. The upgrade may be automatically received at the multi-function device 200 from a server. The upgrade may be received at the multi-function device via a USB, a cloud storage, or any other form of storage. Upon receiving the upgrade, the upgrade controller 218 may communicate with the controller 208 indicating the upgrade is available. The controller 208 then may notify the users of the multi-function device 200 through the user interface 212 or through other ways. The upgrade controller 218 may also reschedule the upgrade for a later hour. If there is any upgrade available, the upgrade controller 218 proceeds further.

The upgrade controller 218 then identifies a module of the plurality of modules of the multi-function device 200, requiring the upgrade based on the upgrade availability. The upgrade may be available for the whole multi-function device 200 or may be available for specific modules such as scan engine 206. In other words, the upgrade controller 218 identifies for which module the upgrade is available. The upgrade may be determined by comparing previous versions of the modules 202-216. The upgrade controller 218 then initiates the upgrade process for the identified one or more modules requiring upgrade. Here, the upgrade is executed for the identified modules, while the upgrade controller 218 continues to provide power to the identified module, for example, scan engine 206 via respective power supply line of the scan engine 206. The upgrade controller 218 further disables power supply for/to the remaining modules of the multi-function device 200, for example, feeder engine 201, print engine 210, user interface 212, finisher engine 216, and so on. The power to each of these modules 201, 210, 212 and 216 is disabled from the start of the upgrade process till completion of the upgrade of the scan engine 206, in order to save power of the multi-function device 200.

The power for each of the modules 201, 210, 212, 216 is disabled by disabling respective power supply lines of the modules 201, 210, 212 and 216. Each power supply line can be disabled by toggling a switch on each power supply line to an open position. For example, the upgrade controller 218 toggles a switch of each of the individual modules such as print engine 210, feeder engine 201, user interface 212 and finisher engine 216, and disables power supply to each of these modules 201, 210, 212, 216.

The upgrade controller 218 continuously monitors the upgrade progress and identifies whether the upgrade for the scan engine 206 is completed or not. Once the upgrade controller 218 determines that the upgrade is completed successfully for the scan engine 206, the upgrade controller 218 enables power again for the modules such as print engine 210, feeder engine 201, and user interface 212 and finisher engine 216 if the upgrade is completed successfully. To enable the power to each of these modules 201, 210, 212 and 216, the upgrade controller 218 toggles a switch provided on each power supply line for modules 201, 210, 212 and 216, to a closed position. The closed position of respective switches continues to provide power to the modules 201, 210, 212 and 216. This way, the upgrade controller 218 saves power of the multi-function device 200 by disabling power for the modules not requiring upgrade i.e., 201, 210, 212 and 216. Once the upgrade is completed, then multi-function device 200 is rebooted and the device 200 operates normally.

Although, the upgrade controller 218 is shown in the form of a module or a component but the upgrade controller 218 may be in the form of an application or app stored in the memory 214 of the multi-function device 200. The upgrade controller 218 controls power of the multi-function device 200 during an upgrade process by disabling power for/to modules not requiring any upgrade or not required to be a part of the upgrade process.

The multi-function device 200 of FIG. 2 is shown to include independent modules 202, 204, 206, 208, 210, 212, 214, 216, and 218, but the device 200 may include other modules as well which may not necessarily have independent power supply lines.

The multi-function device 200 shown in FIG. 2 is just one example, and the disclosure may be implemented for any business-use, personal-use devices, or industrial printers. Various such examples may include office printers, medical printing devices, video printing devices, photo printing machines, copy machines, fax machines, general-purpose printing machines and so on.

### Exemplary Modules with Power Supply Lines

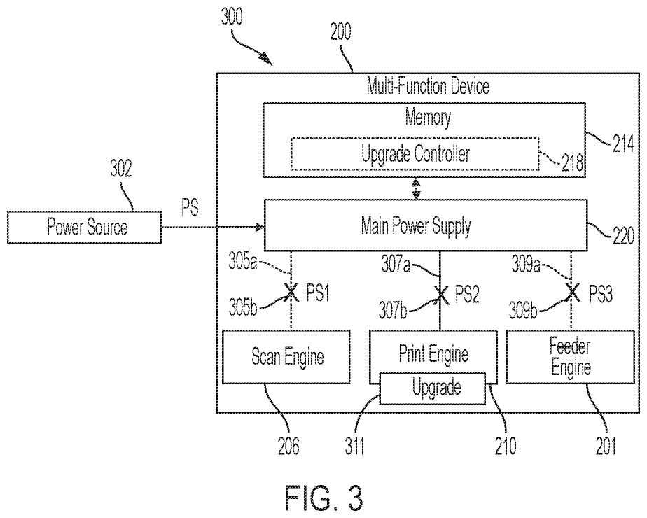

One exemplary diagram 300 is shown in FIG. 3. The diagram 300 is shown to include a multi-function device 200 coupled to an external power source 302 that supplies power to the main power supply 220. The main power supply 220 further provides power to the scan engine 206, the print engine 210, and the feeder engine 201 through individual power lines PS1 305a, 307a, and 309a, respectively. Here, the power supply line 305a represents an individual power supply line for the scan engine 206. The power supply line 307a represents an individual power supply line for the print engine 210 and the power supply line 309a represents an individual power supply line for the feeder engine 201. The power supply lines 305a, 307a and 309a provide required power to the modules 206, 210 and 201, respectively. Each of the individual power lines PS1 305a, PS2 307a, and PS3 309a can be controlled independently by the upgrade controller 218.

As clearly shown, the power supply line 305a includes an individual switch (marked as 305b), the power supply line (marked as 307a) includes a switch 307b, and the power supply line 309a includes a switch (marked as 309b). Each of the switches 305b, 307b and 309b can be used to control the respective power lines 305a, 307a and 309a. For example, the switch 305b can be toggled to disable or enable power supply to the scan engine 206. Similarly, the switch 309b can be toggled to disable or enable power supply to the feeder engine 201. Each of the switches 305b, 307b and 309b can be toggled to an ON state or OFF state. The ON state enables or continues to provide power to a module and the OFF state disables power to a module i.e., stops supplying power to a module. The upgrade controller 218 may be stored in the memory 214 as shown. In the example shown, the upgrade controller 218 initiates upgrade (marked as 311) for the print engine 210. Here, the upgrade controller 218 continues to provide power to the print engine 210 but disables power to the scan engine 206 and the feeder engine 201 through the individual power supply lines 305a and the 309a, respectively. The power for the modules 206 and 201 is disabled by toggling the switches 305b and 309b to OFF state, respectively. The power to the modules 206 and 201 is disabled as the scan engine 206 and the feeder engine 201 are not getting upgrade or also not required during the upgrade process. The upgrade controller 218 enables power for the scan engine 206 and the feeder engine 201 once the upgrade for the print engine 210 is completed successfully. This way, the power is saved for the time, as the scan engine 206 and the feeder engine 201 remains disabled.

### Exemplary Power Circuit Diagram and Load Switch

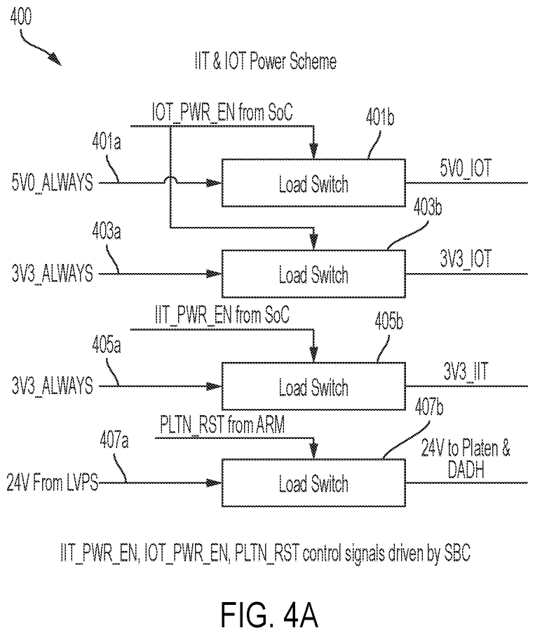

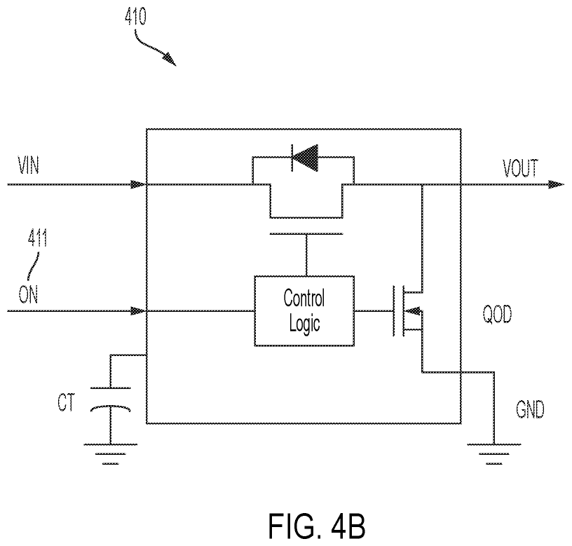

One exemplary power/line circuit diagram 400 is shown in FIG. 4A. The diagram 400 shows individual power supply lines 401a, 403a, 405a, 407a for various modules, where the power can be enabled or disabled by toggling load switches 401b, 403b, 405b and 407b that are deployed on/along the individual power supply lines 401a, 403a, 405a and 407a, respectively. For example, the load switches 403b, 405b and 407b can be turned off to disable or discontinue the power supply. One exemplary load switch with control circuit mechanism to enable or disable power supply lines, is shown in FIG. 4B. The diagram 410 shows one switch added to a module, here the upgrade controller 218 can use the ON (marked as 411) to enable or disable power line for that module.

### Exemplary Flowchart

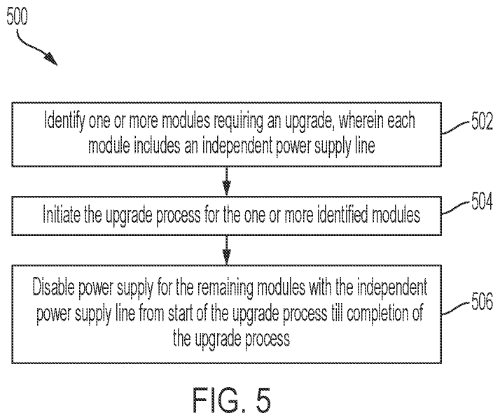

FIG. 5 is a method flowchart 500 for automatically controlling power during an upgrade at a device such as the multi-function device 200. The method 500 is implemented when the upgrade is to be run or executed on one or more specific modules of the multi-function device 200. The upgrade can be automatically pushed by a back-end server or can be downloaded on the multi-function device from an email, a network, a shared location, a cloud storage, Universal Serial Bus (USB), a hard disk, etc.

The method 500 begins when an upgrade is available on the multi-function device and needs to be executed on the multi-function device to enhance its functionality or otherwise. The method 500 can be implemented at the multi-function device by an application running on the device or by an upgrade controller or any other modules. The multi-function device includes a plurality of modules such as print engine, scan engine, feeder engine, user interface, and other modules. Each of these modules include an independent power supply line coupled through a main power supply. Each independent power supply line can be controlled individually and further includes a switch. For example, the switch of a module can be turned-on to enable the power supply for that module or the switch can be turned-off to disable power supply for that module. This is just an example, but the independent power supply line can include any suitable mechanism to enable or disable power supply line for a module.

Once the upgrade is received from the back-end server or from the user, the method 500 starts. It is checked whether the upgrade is available at the multi-function device. Then, it is identified for which one or more modules of the plurality of modules the upgrade is available, at 502. Based on the identification, upgrade process is then initiated for the one or more identified modules requiring upgrade, at 504. Here, power is continuously supplied to the identified modules through individual power supply lines as the modules are getting upgraded.

At 506, power supply is disabled for the remaining modules with independent power supply. The power supply is disabled from the start of the upgrade process till completion of the upgrade process in order to save power of the multi-function device, specifically saves power of the remaining modules as they do not require upgrade. The power is disabled by toggling a switch to open position. This disables the power supply to that particular module i.e., stops providing power supply to that specific module. To disable the power supply, switches that are deployed along the individual power lines to the remaining components are switched-off. This toggling of switch disconnects the power supply to the remaining components to save power. In this manner, the method 500 allows power saving by disabling power supply for the components that are not getting upgraded during the upgrade process. The power for the remaining modules can be enabled again when the upgrade for the one or more identified modules is completed successfully.

The method 500 can be implemented in the form of a non-transitory computer-readable medium including instructions executable by a processing resource. The processing resource is to: identify whether an upgrade is available at a device, wherein the device includes a plurality of modules with independent power supply feature; identify one or more modules of the plurality of modules of the device requiring the upgrade; and initiate upgrade process for the one or more modules requiring upgrade while providing power supply to them; and disable power supply for the remaining modules with the independent power supply from start of the upgrade process till completion of the upgrade process in order to save power.

The non-transitory computer-readable medium, wherein each of the modules include an independent power supply line having a switch for enabling and/or disabling power supply to respective modules. The non-transitory computer-readable medium includes instructions executable by the processing resource to toggle the switch of a module to an open position disables the power supply to that module. The non-transitory computer-readable medium includes instructions executable by the processing resource to toggle the switch of a module to a closed position, enables the power supply to that module. The non-transitory computer-readable medium includes instructions executable by the processing resource to automatically enable the power supply for the remaining modules when the upgrade is completed successfully for the one or more identified modules.

The present disclosure provides methods and systems for automatically controlling power of one or more modules of a multi-function device during an upgrade. The methods and system control power by selectively enabling or disabling power of a module based on an upgrade. For example, if a module requires an upgrade, power is provided to that module. In another example, if a module does not require an upgrade, power to that module is disabled by disabling power supply line of that module. And further the power supply line can be disabled by toggling the switch provided on the power supply line of the module, to an OFF state or an Open position.

In one example, it can be considered that the overall time to upgrade the multi-function device may be 25 mins, where the time to upgrade a scan engine may be 3 mins 30 seconds and the time to upgrade to the print engine may be 3 mins 30 seconds. In scenarios where no upgrade for the scan engine and the print engine is needed, power is disabled for the scan engine and print engine. Here, the power saved is approx. for 25 mins.

In another example, if the overall upgrade time is 40 mins and the scan engine and the print engine requires upgrade. In one example, the time to upgrade the scan engine may be 3 mins 30 seconds and the time to upgrade to the print engine may be 3 mins 30 seconds. Here, power is enabled only when the upgrade for the scan engine is in progress till completion i.e., 3 mins 30 seconds and power is disabled thereafter. Similarly, power is enabled only when the upgrade for the print engine is in progress till completion i.e., 3 mins 30 seconds and power is disabled after upgrade is completed successfully. In such a scenario, the overall power saved is for 36 mins 30 seconds for both—the scan engine and the print engine. These are exemplary and approximate values just for the sake of understanding. The amount of power saving may vary based on the multi-function device, type of the device, type of upgrade, number of modules to be upgraded, time for upgrade or a combination thereof.

The upgrade may run from a few mins such as 5 mins, 10 mins, 25 mins to few hours such as 1 hour, 2 hours, and so on. The multi-function device disables power for modules not requiring any upgrade till the upgrade is completed successfully. The amount of power saved may be based on the amount of time a particular module is disabled and the amount of power that module consumed when functioning.

Although the disclosure is discussed with respect to multi-function devices, but the disclosure can be implemented for any device such as a mobile device that runs on direct power supply or battery storage. In cases where the mobile device requires upgrade, power to the user interface can be disabled till the upgrade is completed successfully.

The methods and systems for automatically saving power at a device such as multi-function device during an upgrade is provided. The methods and systems make the device more reliable in power saving consumptions. The methods and systems are applicable to any type of upgrade. The methods and systems turn-on power for modules only when upgrade is needed for those modules. For example, when upgrade related to a copy controller, a network controller is in progress then power supply to other modules such as scan engine or print engine is not provided. This way, the methods and systems avoid unnecessary power wastage during the upgrade and further enhances the performance of the device. Here, saving power refers to saving power consumption of the device during an upgrade.

The methods and systems can also be implemented for scenarios other than upgrade. For example, power to the user interface can be disabled if there is no user presence near the multi-function and the presence of the user can be determined based on the proximity sensors. Further, power to the user interface can be enabled when the user walks up to the device.

The order in which the method is described is not intended to be construed as a limitation, and any number of the described method blocks can be combined in any order to implement the method or alternate methods. Additionally, individual blocks may be deleted from the method without departing from the spirit and scope of the subject matter described herein. Furthermore, the method can be implemented in any suitable hardware, software, firmware, or combination thereof. However, for ease of explanation, in the embodiments described below, the method may be considered to be implemented in the above-described system and/or the apparatus and/or any electronic device (not shown).

Note that throughout the following discussion, numerous references may be made regarding servers, services, engines, modules, interfaces, portals, platforms, or other systems formed from computing devices. It should be appreciated that the use of such terms is deemed to represent one or more computing devices having at least one processor configured to or programmed to execute software instructions stored on a computer readable tangible, non-transitory medium or also referred to as a processor-readable medium. For example, a server can include one or more computers operating as a web server, database server, or other type of computer server in a manner to fulfill described roles, responsibilities, or functions. Within the context of this document, the disclosed devices or systems are also deemed to comprise computing devices having a processor and a non-transitory memory storing instructions executable by the processor that cause the device to control, manage, or otherwise manipulate the features of the devices or systems.

Some portions of the detailed description herein are presented in terms of algorithms and symbolic representations of operations on data bits performed by conventional computer components, including a central processing unit (CPU), memory storage devices for the CPU, and connected display devices. These algorithmic descriptions and representations are the means used by those skilled in the data processing arts to most effectively convey the substance of their work to others skilled in the art. An algorithm is generally perceived as a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise, as apparent from the discussion herein, it is appreciated that throughout the description, discussions utilizing terms such as receiving, identifying, upgrading, disabling, enabling, initiating, toggling, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The exemplary embodiment also relates to an apparatus for performing the operations discussed herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the methods described herein. The structure for a variety of these systems is apparent from the description above. In addition, the exemplary embodiment is not described with reference to any particular programming language. It will be appreciated that a variety of programming languages may be used to implement the teachings of the exemplary embodiment as described herein.

The methods illustrated throughout the specification, may be implemented in a computer program product that may be executed on a computer. The computer program product may comprise a non-transitory computer-readable recording medium on which a control program is recorded, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

Alternatively, the method may be implemented in a transitory media, such as a transmittable carrier wave in which the control program is embodied as a data signal using transmission media, such as acoustic or light waves, such as those generated during radio wave and infrared data communications, and the like.

The terminology used herein is for the purpose of describing particular embodiments only and is not intended to be limiting of the disclosure. It will be appreciated that several of the above disclosed and other features and functions, or alternatives thereof, may be combined into other systems or applications. Various presently unforeseen or unanticipated alternatives, modifications, variations, or improvements therein may subsequently be made by those skilled in the art without departing from the scope of the present disclosure as encompassed by the following claims.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A method for automatically saving power during an upgrade at a device, the method comprising:
an application running on the device for:
identifying whether an upgrade is available at the device, wherein the device having a plurality of modules, where each module having an independent power supply line to provide power to respective modules;
identifying one or more modules of the plurality of modules requiring the upgrade; and
initiating an upgrade process for the one or more identified modules requiring upgrade by continuing providing power to the one or more identified modules via respective power supply lines;
disabling power supply for the remaining modules not requiring any upgrade, from start of the upgrade process till completion of the upgrade process for the one or more identified modules, in order to save power of the device; and
automatically enabling the power supply for the remaining modules based on successful completion of the upgrade process for the one or more identified modules.

2. The method of claim 1, wherein each of the modules comprise an independent power supply line having a switch for enabling and/or disabling power supply to respective modules.

3. The method of claim 2, further comprising, toggling the switch of a module to an open position disables the power supply to that module.

4. The method of claim 2, further comprising, toggling the switch of a module, to a closed position enables the power supply to that module.

5. (canceled)

6. The method of claim 1, further comprising, automatically disabling the power supply for a module from the start of the upgrade process till completion of the upgrade process, if that module does not require any upgrade or not required to be a part of the upgrade process.

7. A device for saving power during an upgrade at the device, comprising:
a main power supply;
a plurality of modules to perform one or more functionalities, wherein each module comprises an independent power supply line to provide power to respective modules, wherein each independent power supply line is coupled to the main power supply; and
an upgrade controller, communicatively coupled to the main power supply and each of the independent power supply lines of the respective modules, the upgrade controller is for:
identifying whether an upgrade is available at the device;
identifying one or more modules of the plurality of modules of the device, requiring the upgrade;
initiating an upgrade process for the one or more identified modules requiring upgrade by continuing to provide power to the one or more identified modules via respective power supply lines;
disabling power supply for the remaining modules not requiring any upgrade, from start of the upgrade process till completion of the upgrade process, in order to save power; and
automatically enabling the power supply for the remaining modules based on successful completion of the upgrade process for the one or more identified modules.

8. The device of claim 7, wherein each of the modules comprise an independent power supply line having a switch for enabling and/or disabling power supply to respective modules.

9. The device of claim 8, wherein the upgrade controller toggles the switch of a module to an open position for disabling the power supply for that module.

10. The device of claim 8, wherein the upgrade controller toggles the switch of a module to a closed position for enabling the power supply for that module.

11. The device of claim 7, wherein the upgrade controller automatically disables the power supply for a module from the start of the upgrade process till completion of the upgrade process, if the module does not require to be upgraded or not required to be a part of the upgrade process.

12. (canceled)

13. The device of claim 7 is at least one of: a printer, a scanner, a multi-function device, a copier, and a multi-function printer.

14. A non-transitory computer-readable medium comprising instructions executable by a processing resource to:
identify whether an upgrade is available at a device, wherein the device having a plurality of modules, where each module having an independent power supply line to provide power to respective modules;
identify one or more modules of the plurality of modules of the device requiring the upgrade;
initiate an upgrade process for the one or more identified modules requiring upgrade by continuing providing power to the one or more modules via respective power supply lines;
disable power supply for the remaining modules, from start of the upgrade process till completion of the upgrade process in order to save power of the device; and
automatically enable the power supply for the remaining modules based on successful completion of the upgrade process for the one or more identified modules.

15. The non-transitory computer-readable medium of claim 14, wherein each of the modules comprise an independent power supply line having a switch for enabling and/or disabling power supply to respective modules.

16. A multi-function device, comprising:
a main power supply;
a plurality of modules to perform one or more functionalities, wherein each module comprises an independent power supply line to provide power to respective modules, wherein each independent power supply line is coupled to the main power supply; and
an upgrade controller communicatively coupled to the main power supply and each of the independent power supply line for controlling power of each module, during an upgrade process at the multi-function device, wherein the upgrade controller:
disables power for a module, that does not require an upgrade, from start of the upgrade process till completion of the upgrade process, in order to save power of the multi-function device; and
automatically enables the power supply for the module that does not require an upgrade based on successful completion of the upgrade process.

17. The multi-function device of claim 16, wherein the upgrade controller controls the power of each module by at least one of: enabling and disabling power supply to that module based on the upgrade.

18. (canceled)

19. (canceled)

20. The multi-function device of claim 16, wherein the upgrade controller continues to provide power to a module requiring upgrade.
